(19) United States
(12) Patent Application Publication
(10) Pub. No.: US 2009/0226608 A1
(43) Pub. Date: Sep. 10, 2009

(54) APPARATUS AND METHOD FOR COATING PARTICLES

(75) Inventors: Hiroyuki Kato, Yokohama-shi (JP); Isao Umeda, Yokohama-shi (JP); Kazuya Hirata, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: EBARA CORPORATION, OHTA-KU (JP)

(21) Appl. No.: 12/300,568

(22) PCT Filed: May 15, 2007
(86) PCT No.: PCT/JP2007/060325

§ 371 Date: Nov. 12, 2008

(30) Foreign Application Priority Data
May 15, 2006 (JP) 2006-135644

(51) Int. Cl. B05D 7/24; B05C 3/04

(52) U.S. Cl. 427/212; 118/417

(57) ABSTRACT

An apparatus for coating particles with a polymer electrolyte, which includes at least one polymer membrane shell-coating part, the particles being coated with a membrane shell in the at least one polymer membrane shell-coating part by performing a step including contacting the particles having a predetermined charge with the polymer electrolyte having a charge opposite to that of the outer surface of the particles, thereby forming a membrane shell on the surface of the outermost layer of the particles.

### TECHNICAL FIELD

The present invention relates to an apparatus and method for coating particles in which a predetermined membrane shell is formed on the outer surface of the particles. More particularly, the present invention is related to an apparatus and method applicable to coating particles of nano-level size.

Priority is claimed on Japanese Patent Application No. 2006-135644, filed May 15, 2006, the content of which is incorporated herein by reference.

### BACKGROUND ART

In recent years, in the development of various technologies, such as drug development in the field of leading medical applications, and development of materials for electro-components in the field of electronics, many studies have been made on particles having a particle diameter of a nano-level size.

As techniques for producing such particles, various methods have conventionally been proposed, such as a method in which particles are chemically produced, a method in which particle size-reduction is mechanically performed using a pulverizing apparatus called a “wet ball mill”, and a method in which particle size-reduction is performed by irradiation of laser beam (see, for example, Patent Document 1).

However, even when such particles are produced by any of these methods, it is highly possible that the produced particles will agglomerate with each other due to the surface energy thereof. Therefore, it was difficult to maintain the size of the produced particles. For solving this problem, for example, a technique has been proposed in which agglomerated particles formed as a result of agglomeration of particles are mixed together with stirring particles (media) in a solvent, and the resulting mixture is stirred to pulverize the agglomerated particles, thereby dispersing pulverized particles in the solvent (see, for example, Patent Document 2).

Patent Document 1: Japanese Unexamined Patent Application, First Publication No. 2001-113159

Patent Document 2: Japanese Unexamined Patent Application, First Publication No. 2005-87972

### DISCLOSURE OF INVENTION

### Problems to be Solved by the Invention

In Patent Document 2, for example, agglomerate particles formed by agglomeration of particles having an average primary particle diameter of 100 nm or less are mixed together with stirring particles having an average particle diameter of 1 to 30 μm in a solvent such as water or an organic solvent, and the resulting mixture is stirred to pulverize the agglomerated particles. However, in this document, addition of a dispersant to the resulting mixture is the only measure for preventing re-agglomeration of pulverized particles. Therefore, re-agglomeration of pulverized particles is highly possible, which means that production of particles that are usable in practical applications cannot be realized by the method disclosed in this document. Further, stirring particles become worn by stirring, which may result in generation of impurities contaminating the solvent containing the particles.

Accordingly, an object of the present invention is to provide an apparatus and method which can solve the above-mentioned problems of the prior art, namely, an apparatus and method which enable production of particles which are permanently prevented from agglomeration and usable in practical applications, and which are further prevented from contamination by impurities.

### Means to Solve the Problems

For solving the above-mentioned problems, the apparatus for coating particles according to the present invention employs the following embodiments. One embodiment of the present invention is an apparatus for coating particles with a polymer electrolyte, which includes at least one polymer membrane shell-coating part, the particles being coated with a membrane shell in the at least one polymer membrane shell-coating part by performing, once or a plurality of times, a step including contacting the particles having a predetermined charge with the polymer electrolyte having a charge opposite to that of the outer surface of the particles, thereby forming a membrane shell on the surface of the outermost layer of the particles.

Herein, the term “particles” includes particles having various particle diameters, such as particles having a particle diameter in the micron (μm) order, and particles (fine particles) having a particle diameter in the nano (nm) order. Especially, it is highly possible that particles of nano-order agglomerate due to the surface energy thereof. Therefore, it is necessary to prevent agglomeration, for example, by coating the surface of the particles.

In the present embodiment, particles prior to coating have a positive or negative charge on the outer surface thereof. A charge can be imparted to the outer surface of particles, for example, by any of the following methods: a method in which particles are put into a desired liquid such as water to thereby ionize the surface of the particles, a method in which an electric field is applied to particles to thereby charge the particles; and a method in which the surface of particles of a neutral organic compound is covered with a desired surfactant to form particles in a suspended state. Further, any other method can be used to impart a charge to the surface of particles.

In view of the object of coating particles, when the particles have a charge within a liquid, it is preferable that the particles be insoluble or hardly soluble in the liquid, such that the particles are in a state of suspension within the liquid. A preferred example of such suspended particles having a charge within a liquid includes an organic compound having a carboxyl group or a basic nitrogen-containing group within the structure thereof and which is insoluble or hardly soluble in the liquid.

Next, the term “polymer electrolyte” is explained. The term “polymer electrolyte” refers to a polymeric compound exhibiting the properties of an “electrolyte”. An “electrolyte” is a substance which, when dissolved in a liquid, imparts electroconductivity to the liquid. More specifically, an electrolyte is ionized in the liquid, and this ion formed transfers electric charge when an electric field is applied.

Examples of polymer electrolytes include biocompatible polymers, such as protamine, gelatin A, collagen, albumin, casein, chitosan, poly-(L)-lysine, carboxymethyl cellulose, alginate, heparin, hyaluronic acid, chondroitin sulfate, gelatin B, carageenan, dextran sulfate, and poly-(L)-glutamic acid; biopolymers, such as biodegradable polymers, DNA, RNA, enzymes and antibodies; synthesized polymers, such as polymethacrylic acid, polydiaryldimethylammonium; and polymers in which such synthesized polymers are crosslinked with an appropriate linker. However, polymer electrolytes are not limited to these examples.

In the present embodiment, the polymer electrolyte can be contacted with the outer surface of the particles, for example, by any of the following methods. When the particles and the polymer electrolyte are independently contained in a liquid, the particle suspension (i.e., the liquid containing the particles) and the polymer electrolyte solution (i.e., liquid containing polymer electrolyte) may be mixed together. On the other hand, when the particles are not contained in a liquid, the particles may be put into the polymer electrolyte solution. Alternatively, in such a case where the particles are not contained in a liquid, the polymer electrolyte solution may be sprayed onto the particles, or the polymer electrolyte solution may be applied onto the particles. Further, any other contacting methods may be used.

In addition, in such a case where the particles are not contained in a liquid, oxidation or intrusion of impurities may be prevented by performing the coating treatment in a vacuum or gaseous atmosphere.

In the present embodiment, for example, when the outer surface of the particles prior to coating has a negative charge, firstly, the outer surface of the particles is contacted with a cationic polymer electrolyte having a positive charge to form a cationic membrane shell as a first layer. Then, if desired, the surface of the outermost layer of the particles having the cationic membrane shell formed as the first layer is contacted with an anionic polymer electrolyte having a negative charge, thereby obtaining particles having a cationic membrane shell as a first layer and an anionic membrane shell as a second layer formed on the cationic membrane shell. Thereafter, if desired, the particles may be alternately contacted with a cationic polymer electrolyte and an anionic polymer electrolyte in this order, thereby forming a desired number of layers of membrane shell on the outer surface of the particles.

Likewise, when the outer surface of the particles prior to coating has a positive charge, firstly, the outer surface of the particles is contacted with an anionic polymer electrolyte having a negative charge to form an anionic membrane shell as a first layer. Then, if desired, the surface of the outermost layer of the particles having the anionic membrane shell formed as the first layer is contacted with a cationic polymer electrolyte, thereby obtaining particles having an anionic membrane shell as a first layer and a cationic membrane shell as a second layer formed on the anionic membrane shell. Thereafter, if desired, the particles may be alternately contacted with an anionic polymer electrolyte and a cationic polymer electrolyte in this order, thereby forming a desired number of layers of membrane shell on the outer surface of the particles.

The present embodiment includes the case where only one layer of membrane shell is formed on the outer surface of the particles.

In the present embodiment, the particles are contacted with a polymer electrolyte having a charge opposite to that of the outermost layer of the particles. In such a case, the outermost layer of the particles and the polymer electrolyte are attracted to each other by electrostatic force, so that coating can be easily performed, and strong membrane shells can be formed. Further, in the present embodiment, when a membrane shell is formed to a certain thickness, the electrostatic force attracting the outermost layer of the particles and the polymer electrolyte to each other is no longer generated, so that a membrane shell having a certain thickness can be easily formed. Furthermore, in the present embodiment, since stirring particles (media) or the like are not used, intrusion of impurities can be prevented.

As the polymer electrolyte for the odd-numbered layers (i.e., the first layer, the third layer, the fifth layer, and so on), the same polymer electrolyte may be used, or different types of polymer electrolytes having a charge of the same pole may be used. Likewise, as the polymer electrolyte for the even-numbered layers (i.e., the second layer, the fourth layer, the sixth layer, and so on), the same polymer electrolyte may be used, or different types of polymer electrolytes having a charge of the same pole may be used.

The steps for forming the membrane shells of the respective layers may be repeatedly performed by using the same coating-treatment means (hereafter, frequently referred to as “polymer membrane shell-coating part”), or by using different coating-treatment means. Further, the coating of the particles may be performed continuously, or a predetermined amount of particles may be coated in a batchwise manner.

According to the coating apparatus of the present embodiment, by using a polymer electrolyte having a charge opposite to that of the outermost surface of the particles, the coating of the particles can be performed reliably with ease, and a desired number of layers of strong membrane shells having a certain thickness can be formed.

Further, by performing the coating of the particles using a polymer electrolyte, agglomeration of particles can be permanently prevented, and intrusion of impurities can be prevented. Especially, the apparatus for coating particles according to the present invention can prevent agglomeration of particles having a particle diameter of nano-order. Therefore, the present invention can greatly contribute to application of such particles in medical and industrial fields, which was difficult to achieve for practical use.

According to another embodiment of the apparatus of the present invention for coating particles, the particles and the polymer electrolyte are contained in a particle suspension and a polymer electrolyte solution, respectively, and the particle suspension and the polymer electrolyte solution are mixed together to contact the surface of the outermost layer of the particles with the polymer electrolyte.

In the present embodiment, the particles contained in the particle suspension and the polymer electrolyte contained in the polymer electrolyte solution are ionized to exhibit a charge. When a particle suspension containing particles and a polymer electrolyte solution having a charge opposite to that of the outermost layer of the particles are used, the outermost layer of the particles and the polymer electrolyte are attracted to each other by electrostatic force, so that strong membrane shells can be easily formed by simply mixing together the particle suspension and the polymer electrolyte solution.

According to still another embodiment of the apparatus of the present invention for coating particles, the particle suspension and the polymer electrolyte solution are mixed together by merging the flow of the particle suspension with the flow of the polymer electrolyte solution.

In the present embodiment, the coating can be easily performed by merging the flow of the particle suspension with the flow of the polymer electrolyte solution. Further, the present embodiment is suitable for performing continuous coating. Therefore, especially when the production step of the particles is continuously performed, coating treatment can be performed successively, thereby enabling efficient production of particles free from agglomeration.

According to still another embodiment of the apparatus of the present invention for coating particles, the particle suspension and the polymer electrolyte solution are passed through a microflow channel.

Herein, the term “microflow channel” means a flow channel which is formed by precise processing and which has a width of micron order. By passing the particle suspension through a microflow channel, the number of particles flowing at a time can be controlled, so that agglomeration of particles prior to coating can be effectively prevented. Further, when a microflow channel having a plurality of channels is used, a multitude of coating treatments of particles can be performed simultaneously, thereby enhancing the productivity.

According to still another embodiment of the apparatus of the present invention for coating particles, the particle suspension and the polymer electrolyte solution are mixed together, followed by separating and collecting particles from the resulting mixture of the particle suspension and the polymer electrolyte solution, and a new particle suspension containing the separated and collected particles is mixed with a polymer electrolyte solution having a charge opposite to that of the outermost layer of the particles contained in the new particle suspension.

In the present embodiment, membrane shell-coated particles are separated and collected from the mixture of the particle suspension and the polymer electrolyte solution, and the subsequent coating step is performed using a new particle suspension containing the separated and collected particles. Therefore, the membrane shells of the respective layers can be prevented from containing impurities, so that strong membrane shells of high quality can be formed.

According to still another embodiment of the apparatus of the present invention for coating particles, the particles are separated and collected from the resulting mixture of the particle suspension and the polymer electrolyte solution by using a filter.

In the present embodiment, the particles can be reliably separated and collected from the mixture of the particle suspension and the polymer electrolyte solution by using a filter which has a mesh size which allows the polymer electrolyte to pass therethrough but not the particles. Examples of filters include MF filters and UF filters. As the material for the filter, a cellulose ester, a polysulfone, a polyester sulfone, or the like is preferred. The pore diameter of the filter is preferably 40 nm or more. Further, the filter may be used in the form of a hollow fiber or an ultrafiltration membrane. Furthermore, by imparting a charge to the filter membrane, charged particles can be adsorbed or repulsed. Therefore, when a cationic membrane shell is used for positively charged particles and an anionic membrane shell is used for negatively charged particles, it becomes possible to allow only polymer electrolyte to pass through the filter.

As a method for collecting the particles captured by the filter, there can be mentioned a method in which the particles are removed from the filter by back washing, or a method in which the particles are mechanically removed from the filter.

According to still another embodiment of the apparatus of the present invention for coating particles, the apparatus is provided with a rotary roller having a charge opposite to that of the outermost layer of the particles in the resulting mixture of the particle suspension and the polymer electrolyte solution. The particles in the resulting mixture of the particle suspension and the polymer electrolyte solution are separated from the mixture by capturing the particles on the surface of the rotary roller at a position where the surface of the rotary roller contacts with the resulting mixture of the particle suspension and the polymer electrolyte solution, and the captured particles are removed and collected from the surface of the rotary roller at a position remote from the resulting mixture of the particle suspension and the polymer electrolyte solution.

As a mode for imparting, to the surface of the rotary roller, a charge opposite to that of the outermost layer of the particles, for example, a mode in which an anionic or cationic electrodeposition film is applied on the surface of the rotary roller, or a mode in which an electric field is applied to the surface of the rotary roller, can be used. Further, any other modes for imparting a charge may be used.

According to still another embodiment of the apparatus of the present invention for coating particles, the captured particles are removed from the surface of the rotary roller by spraying the surface of the rotary roller with a liquid.

In the present embodiment, when a liquid which is the same as that used for the particle suspension is used as the liquid for spraying the surface of the rotary roller, a new particle suspension containing the separated and collected particles can be obtained directly.

According to still another embodiment of the apparatus of the present invention for coating particles, the apparatus is provided with a microelectrostatic elimination device for canceling the charge on the surface of the rotary roller.

Herein, a “microelectrostatic elimination device” is a device for removing static electricity by, for example, applying voltage, using a corona discharge, using photoionization, or using any other methods for removing static electricity.

By the present embodiment, particles can be removed from the surface of the rotary roller more reliably.

According to still another embodiment of the apparatus of the present invention for coating particles, the pole of the charge of the surface of the rotary roller is switchable depending on the rotating position. The particles in the resulting mixture of the particle suspension and the polymer electrolyte solution are separated therefrom by switching the charge of the surface of the rotary roller to the pole opposite to that of the charge of the outermost layer of the membrane shell-coated particles and capturing the particles on a surface of the rotary roller at a position where the surface of the rotary roller contacts with the resulting mixture of the particle suspension and the polymer electrolyte solution. Further, the captured particles are removed and collected from the surface of the rotary roller at a position remote from the resulting mixture of the particle suspension and the polymer electrolyte solution by switching the charge of the surface of the rotary roller to the same pole as that of the charge of the outermost layer of the membrane shell-coated particles.

In the present embodiment, the charge of the surface of the rotary roller is switched to the pole opposite to that of the charge of the outermost layer of the particles in the resulting mixture of the particle suspension and the polymer electrolyte solution, so as to attract and capture the particles by static electricity. Then, the charge of the surface of the rotary roller is switched to the same pole as that of the charge of the outermost layer of the captured particles, thereby generating a repulsive force by static electricity to reliably remove the particles captured on the surface of the rotary roller. This embodiment can be combined with the above-mentioned embodiment in which the surface of the rotary roller is sprayed with a liquid, so as to remove particles more reliably.

According to still another embodiment of the apparatus of the present invention for coating particles, the apparatus for coating particles is connected to an apparatus for producing particles, and a step for producing the particles is performed, followed by the coating of the particles with the polymer electrolyte.

In the present embodiment, coating of the particles with the polymer electrolyte can be performed following the production step of particles (i.e., step of downsizing particles), so that agglomeration of the produced particles can be reliably prevented. Especially, by connecting an apparatus for continuously producing particles to an apparatus of the present invention for coating particles which is capable of continuous coating, a continuous particle manufacturing system with high production efficiency can be constituted.

One embodiment of the method for coating particles according to the present invention is a method for coating particles with a polymer electrolyte, including: providing particles having a predetermined charge on the outer surface thereof and a polymer electrolyte having a charge opposite to that of the outer surface of the particles; and coating the particles with said polymer electrolyte by performing, a desired number of times, a step including contacting the particles with the polymer electrolyte, thereby forming a desired number of layers of membrane shells on the outer surface of the particles.

According to another embodiment of the method of the present invention for coating particles, the particles and the polymer electrolyte are contained in a particle suspension and a polymer electrolyte solution, respectively, and the particle suspension and the polymer electrolyte solution are mixed together to contact the surface of the outermost layer of the particles with the polymer electrolyte.

According to still another embodiment of the method of the present invention for coating particles, the particle suspension and the polymer electrolyte solution are mixed together by merging the flow of the particle suspension with the flow of the polymer electrolyte solution.

### EFFECT OF THE INVENTION

As described hereinabove, by using the apparatus and method for coating particles according to the present invention, a desired number of layers of a strong membrane shell having a certain thickness can be reliably formed on the outer surface of the particles with ease. Further, agglomeration of particles can be permanently prevented, and intrusion of impurities can also be prevented.

In addition, by performing a step for producing (downsizing) particles, followed by coating of the produced particles with a polymer electrolyte, a continuous particle manufacturing system can be constituted. Especially, by continuously performing the step for producing particles, followed by continuous coating, a continuous particle manufacturing system with high production efficiency can be constituted.

### BRIEF DESCRIPTION OF THE DRAWINGS

FIG. 1 is a schematic diagram showing one embodiment of a continuous particle manufacturing system including the coating apparatus of the present invention.

FIG. 2 is a diagram showing one embodiment of a coating part using a single microflow channel.

FIG. 3 is a diagram showing one embodiment of a coating part using a multi-microflow channel.

FIG. 4 is a line diagram showing a general view of one embodiment of the apparatus and method for coating particles according to the present invention, following the flow of the particle suspension and the polymer electrolyte solution.

FIG. 5 is a schematic diagram showing one embodiment of a separation/collection component in which cationic or anionic membrane shell-coated particles are separated and collected using a filter.

FIG. 6 is a schematic diagram showing one embodiment of a separation/collection component in which cationic or anionic membrane shell-coated particles are separated and collected using a rotary roller.

FIG. 7 is a schematic diagram showing other embodiment 1 of a separation/collection component in which cationic or anionic membrane shell-coated particles are separated and collected using a rotary roller.

FIG. 8A is a schematic diagram showing other embodiment 2 of a separation/collection component in which cationic or anionic membrane shell-coated particles are separated and collected using a rotary roller.

FIG. 8B is a perspective view of the rotary roller shown in FIG. 8A.

FIG. 9A is a perspective view of one embodiment of a separation/collection component in which cationic or anionic membrane shell-coated particles are separated and collected using a flow channel having an electric charge.

FIG. 9B is a perspective view showing the step in which cationic or anionic membrane shell-coated particles captured in the flow channel of the separation/collection component shown in FIG. 9A are collected by washing off the particles.

### REFERENCE NUMERALS

2 Continuous particle manufacturing system
4 Apparatus for coating particles
6 Apparatus for producing particles
12 Vessel for initial particle suspension
14a, 14b Pump
16 Pump
20 Cationic membrane shell-coating part
22a Microflow channel for particle suspension
22b Microflow channel for cationic polymer electrolyte solution
22c Merged microflow channel
24 Tank for cationic polymer electrolyte solution
26 Pump
30 Anionic membrane shell-coating part
32a Microflow channel for particle suspension
32b Microflow channel for anionic polymer electrolyte solution
32c Merged microflow channel
34 Tank for anionic polymer electrolyte solution
36 Pump
40 Separation/collection component
40a Separation/collection component for cationic membrane shell-coated particles
40b Separation/collection component for anionic membrane shell-coated particles
42a Nanoparticle filter for cationic membrane shell-coated particles
42b Nanoparticle filter for anionic membrane shell-coated particles
44a, 44b Pump
46a, 46b Pump
48a Collecting vessel for cationic mixture
48b Collecting vessel for anionic mixture
60a Collecting vessel for suspension of cationic membrane shell-coated particles
60b Collecting vessel for suspension of anionic membrane shell-coated particles
62 Pump
64 Collecting vessel for multilayer membrane shell-coated particles
80 Nozzle
82 Rotary roller
82a Roller surface
84 Collecting vessel for anionic mixture
86 Spraying nozzle
88 Collecting vessel for suspension of anionic membrane shell-coated particles
90, 90a, 90b Separator
92 Microelectrostatic elimination device
100 Rotary roller
102 Capturing piece
102a Surface of capturing piece (surface of roller)
102b Protruding portion
104 Support ring
104a Through-hole
106a, 106b Electrode ring
108 Insulation ring
202 Flow channel
204 Nozzle for washing water
206 Collecting vessel for suspension of anionic membrane shell-coated particles
208 Rotary plate
208a Center of rotation

### BEST MODE FOR CARRYING OUT THE INVENTION

Hereinbelow, various embodiments of the apparatus and method for coating particles according to the present invention will be described in detail with reference to the drawings.

### (Explanation of a Particle Manufacturing System Including the Coating Apparatus of the Present Invention)

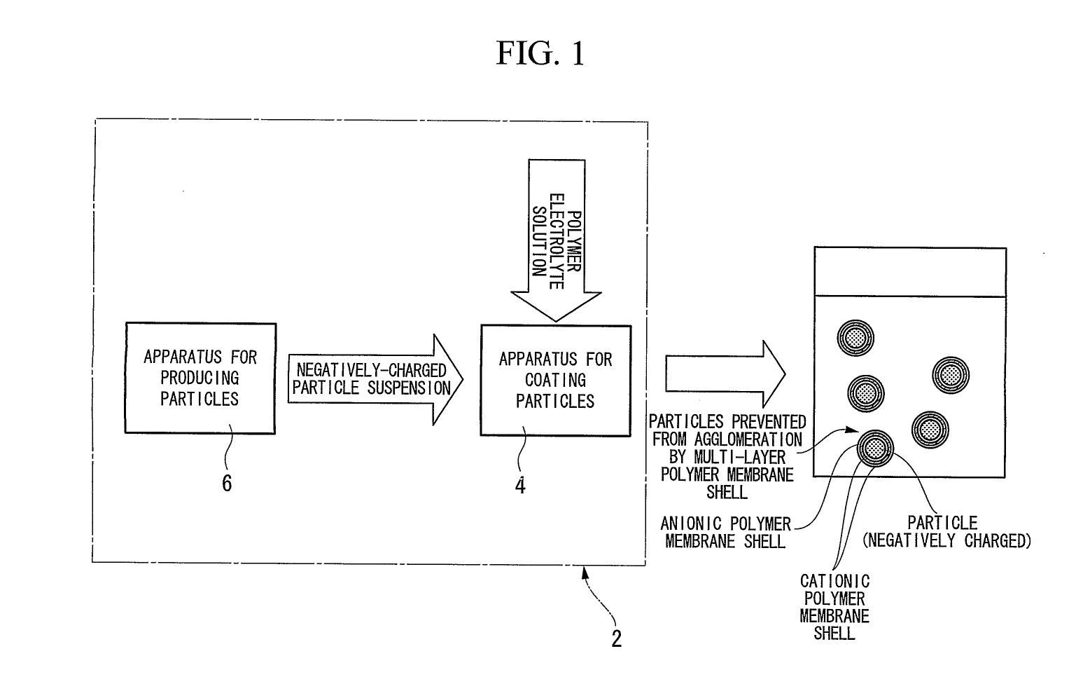

FIG. 1 is a schematic diagram showing one embodiment of a continuous particle manufacturing system 2 including a coating apparatus 4 of the present invention. A particle suspension containing particles produced in the apparatus for producing particles 6 is supplied to the coating apparatus 4 of the present invention. As the particles to be supplied, particles of various particle diameters from micron size to nano size may be used.

As the apparatus for producing particles 6 used in the continuous particle manufacturing system 2, any apparatus can be used. For example, an apparatus in which particle size-reduction is mechanically performed using a wet ball mill, or an apparatus in which particle size-reduction is performed by irradiation of laser beam, can be used. Further, an apparatus in which particles are produced either in a continuous manner or in a batchwise manner may be used.

In the coating apparatus 4 according to the present invention, the particle suspension supplied may be mixed with a polymer electrolyte solution to form a multi-layered membrane shell of the polymer electrolyte on the outer surface of the particles. In the embodiment shown in FIG. 1, as an example, the particles in the particle suspension are ionized to exhibit a negative charge. As the polymer electrolyte solution for forming a membrane shell, a cationic polymer electrolyte solution in which the polymer electrolyte is ionized to exhibit a positive charge, or an anionic polymer electrolyte solution in which the polymer electrolyte is ionized to exhibit a negative charge, may be used.

In the coating apparatus 4, firstly, the particle suspension is mixed with a cationic polymer electrolyte solution having a positive charge which is opposite to the negative charge of the outer surface of the particles, to thereby form a cationic membrane shell composed of the cationic polymer electrolyte on the outer surface of the particles. Then, a new particle suspension containing the cationic membrane shell-coated particles is mixed with an anionic polymer electrolyte solution having a negative charge which is opposite to the positive charge of the outermost layer of the cationic membrane shell-coated particles, to thereby form an anionic membrane shell composed of the anionic polymer electrolyte on the outermost layer of the cationic membrane shell-coated particles.

Further, a new particle suspension containing the thus obtained particles coated with the anionic membrane shell on the outermost layer is mixed with a cationic polymer electrolyte solution having a positive charge which is opposite to the negative charge of the outermost layer of the particles, to thereby form a cationic membrane shell composed of the cationic polymer electrolyte on the outermost layer of the particles.

The thus obtained particles having three layers of polymer electrolyte membrane shells formed on the outersurface thereof are shown on the right-hand side in FIG. 1. By forming these membrane shell layers, agglomeration of particles can be prevented in advance.

As the method for mixing a particle suspension with a polymer electrolyte solution, both fluids can be fed into the same vessel and mixed together, or, as described below, the flow of the particle suspension can be merged with the flow of the polymer electrolyte solution.

In either of these cases, particles are contacted with a polymer electrolyte solution having a charge opposite to that of the outermost layer of the particles, so that the outermost layer of the particles and the polymer electrolyte are attracted to each other by electrostatic force. Thus, coating can be easily performed by simply mixing together the particle suspension and the polymer electrolyte solution, and strong membrane shells can be formed. Further, when a membrane shell is formed to have a certain thickness, electrostatic force which causes attraction of opposing charges is no longer generated. Thus, a membrane shell having a certain thickness can be easily formed.

In the coating method as shown in FIG. 1 in which a particle suspension and a polymer electrolyte solution are used, coating of particles can be easily performed by simply mixing together the particle suspension and the polymer electrolyte solution. Therefore, the coating method shown in FIG. 1 is a preferable method. However, the method for coating particles according to the present invention is not limited to this method, and coating can be performed with respect to particles which are not contained in a liquid. For example, particles themselves can be put into the polymer electrolyte solution, or the polymer electrolyte solution can be sprayed onto the particles, or the polymer electrolyte solution can be applied onto the particles. In addition, oxidation or intrusion of impurities can be prevented by performing the coating treatment in a vacuum or gaseous atmosphere.

### (Explanation of Polymer Membrane Shell-Coating Part Used in the Present Invention)

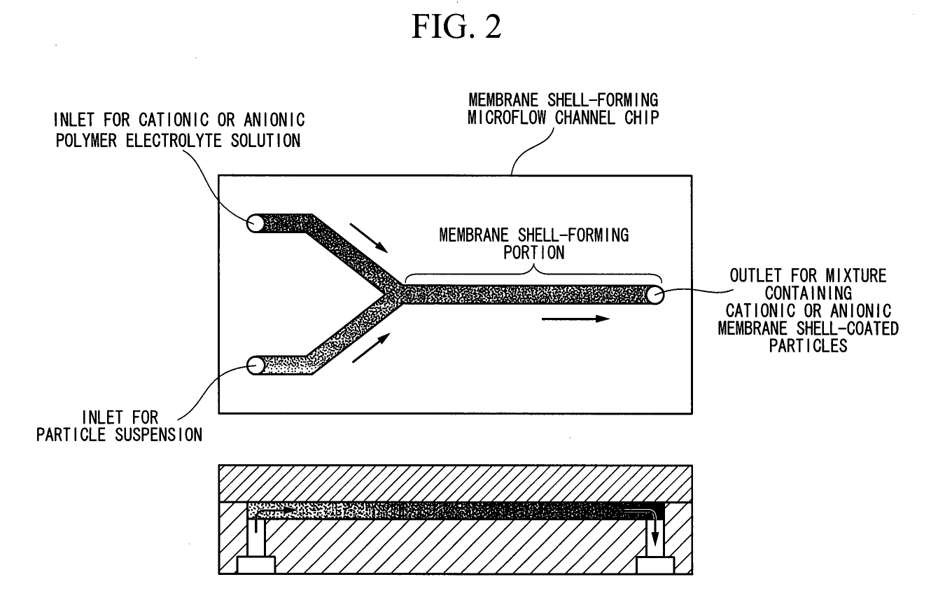

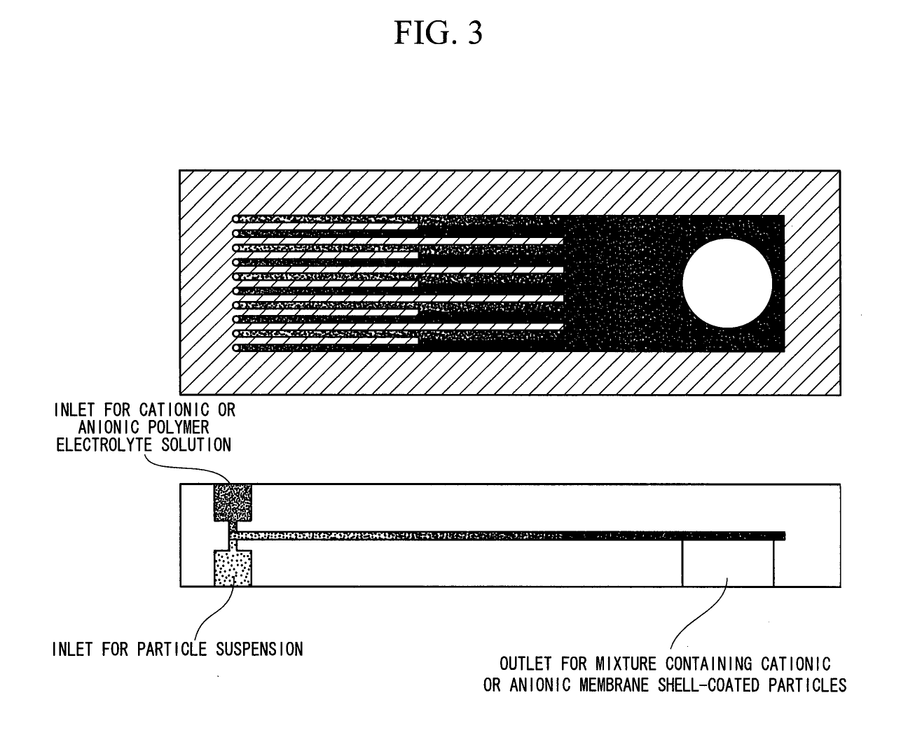

Next, one embodiment of the polymer membrane shell-coating part in which a particle suspension and a polymer electrolyte solution are used to form a polymer electrolyte membrane shell on the outer surface of the particles is explained, with reference to FIGS. 2 and 3. The polymer membrane shell-coating part is one of the main components of the apparatus for coating particles according to the present invention.

In the present embodiment, coating is performed by merging the flow of the particle suspension with the flow of the polymer electrolyte solution. Further, in the present embodiment, both of the particle suspension and the polymer electrolyte solution are passed through a microflow channel. FIG. 2 shows an embodiment of a polymer membrane shell-coating part using a single microflow channel in which the particle suspension and the polymer electrolyte solution are respectfully passed through microflow channels which merge together. FIG. 3 shows an embodiment of a polymer membrane shell-coating part using a multi-microflow channel which is provided with a plurality of single microflow channels shown in FIG. 2.

Firstly, an explanation is given below of the embodiment of a polymer membrane shell-coating part using a single microflow channel as shown in FIG. 2.

Herein, the term “microflow channel” means a flow channel which is formed by precise processing and which has a width of micron order. This microflow channel is effective in preventing agglomeration of particles downsized by the apparatus for producing particles. It is especially preferable to set the width of the microflow channel slightly larger than the maximum diameter of the particles flowing within the particle suspension. However, in view of the fluctuation of particle diameter and precision in producing the microflow channel, the width of the microflow channel is preferably set in the range of 1.1 to 500 times, more preferably 50 to 500 times of the maximum diameter of the particles flowing. In the present embodiment, water is used to suspend the particles.

Further, the microflow channel through which the polymer electrolyte solution is passed can be set at the same size as the above-mentioned microflow channel through which the particle suspension is passed. The polymer electrolyte solution passed through the microflow channel contains a polymer electrolyte having a charge opposite to that of the outermost layer of the particles to be coated. Namely, when the outermost layer of the particles contained in the particle suspension has a negative charge, a cationic polymer electrolyte solution having a positive charge is passed through the microflow channel. Likewise, when the outermost layer of the particles contained in the particle suspension has a positive charge, an anionic polymer electrolyte solution having a negative charge is passed through the microflow channel.

In the present embodiment, the microflow channel through which the particle suspension is passed merges with the microflow channel through which the polymer electrolyte solution is passed at an angle of about 75 degrees. However, in the present invention, the angle at which the microflow channels merge can be selected from acute angles to obtuse angles. The angle at which the microflow channels merge is preferably from 0 to 180 degrees, more preferably from 0 to 5 degrees especially for multi micro flow channel.

When the particles are alternately coated with a cationic polymer electrolyte membrane shell (cationic membrane shell) and an anionic polymer electrolyte membrane shell (anionic membrane shell), it is necessary that the polymer membrane shell-coating part have at least one pair of a cationic membrane shell-coating part in which a microflow channel through which a particle suspension is passed merges with a microflow channel through which a cationic polymer electrolyte solution is passed, and an anionic membrane shell-coating part in which a microflow channel through which a particle suspension is passed merges with a microflow channel through which an anionic polymer electrolyte solution is passed.

As explained above, in each of the polymer membrane shell-coating parts, a particle suspension and a polymer electrolyte having a charge opposite to that of the outermost layer of the particles are used. Therefore, the particles and the polymer electrolyte are attracted to each other by electrostatic force by simply merging the flow of the particle suspension and the flow of the polymer electrolyte solution, so that strong membrane shells can be easily formed.

Next, an explanation is given of the polymer membrane shell-coating part shown in FIG. 3, which uses a multi-microflow channel. The polymer membrane shell-coating part of this embodiment uses a multi-microflow channel provided with 5 sets of polymer membrane shell-coating parts using the above-mentioned single microflow channel.

In the polymer membrane shell-coating part of the present embodiment, coating is performed in the same manner as explained above in connection with the polymer membrane shell-coating part using the single microflow channel. However, in this embodiment, the amount of particles which can be coated at a time is five times larger, so that a polymer membrane shell-coating part with high productivity can be realized.

With respect to the number of microflow channels to be provided, it is preferable to determine the optimum number depending on the required production rate of the particles. Especially, when particles are continuously produced (downsized) by the particle production apparatus provided at the upstream of the coating apparatus, by providing a polymer membrane shell-coating part capable of treating the particle suspension in an amount equal to or larger than that of the particle suspension flowed from the particle production apparatus, it becomes possible to realize a continuous particle manufacturing system which can successively perform particle production and coating treatment.

### (General Explanation of the Apparatus and Method for Coating Particles According to the Present Invention)

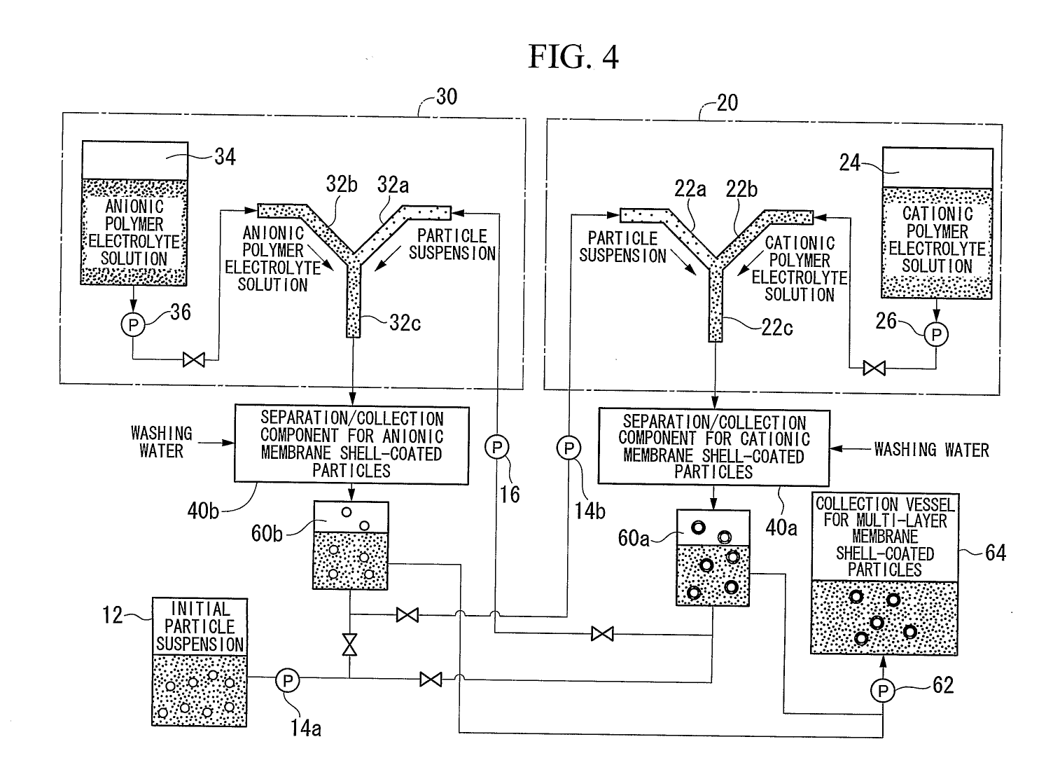

Next, an explanation is given of one embodiment of the apparatus for coating particles according to the present invention which has the above-mentioned polymer membrane shell-coating part using a microflow channel, and the method for coating particles according to the present invention, with reference to FIG. 4.

FIG. 4 is a line diagram showing a general view of one embodiment of the apparatus and method for coating particles according to the present invention, following the flow of the particle suspension and the polymer electrolyte solution.

As shown in FIG. 4, the apparatus for coating particles according to the present embodiment is mainly composed of: a vessel 12 for initial particle suspension, which is capable of storing a suspension of particles prior to coating; a cationic membrane shell-coating part 20 for forming cationic membrane shells on particles; an anionic membrane shell-coating part 30 for forming anionic membrane shells on particles; separation/collection components 40a and 40b for separating and collecting polymer membrane shell-coated particles obtained in the cationic membrane shell-coating part 20 and the anionic membrane shell-coating part 30; a collection vessel 64 for multilayer membrane shell-coated particles, where polymer membrane shell-coated particles following the series of coating treatment are collected; conduits for connecting each of the components; pumps for transferring fluids to various devices; and valves for opening and closing conduits to thereby flow fluids to predetermined conduit routes.

Further, the cationic membrane shell-coating part 20 is mainly composed of: a microflow channel 22a for particle suspension; a microflow channel 22b for cationic polymer electrolyte solution; a merged microflow channel 22c which is formed by merging of the microflow channel 22a with the microflow channel 22b; a tank 24 for cationic polymer electrolyte solution, where a cationic polymer electrolyte solution is stored; pumps; conduits; and valves. Likewise, the anionic membrane shell-coating part 30 is mainly composed of: a microflow channel 32a for particle suspension; a microflow channel 32b for anionic polymer electrolyte suspension; a merged microflow channel 32c which is formed by merging of the microflow channel 32a with the microflow channel 32b; a tank 34 for anionic polymer electrolyte solution, where an anionic polymer electrolyte solution is stored; pumps; conduits; and valves.

For the sake of simplifying the figure, the microflow channels used in the polymer membrane shell-coating parts 20 and 30 are shown in the form of single microflow channels. However, in practice, multi-microflow channels having the required number of microflow channels corresponding to the production rate of particles can be used.

Next, an explanation is given following the flow of the particle suspension. The suspension of particles prior to coating produced by the particle production apparatus 6 (shown in FIG. 1) is stored in the vessel 12 for initial particle suspension. Also in the present embodiment, particles are suspended in water, and the outer surfaces of the particles are ionized in water to exhibit a negative charge.

In this state, using the pumps 14a and 14b, the suspension of the particles prior to coating is transferred from the vessel 12 for initial particle suspension to the microflow channel 22a for particle suspension provided within the cationic membrane shell-coating part 20. Likewise, using a pump 26, the cationic polymer electrolyte solution stored in a tank 24 for cationic polymer electrolyte solution is transferred to the microflow channel 22b for cationic polymer electrolyte solution.

Then, the microflow channel 22a for particle suspension and the microflow channel 22b for cationic polymer electrolyte solution merge together to form a merged microflow channel 22c. In the merged microflow channel 22c, the particle suspension and the cationic polymer electrolyte solution are mixed together, whereby the outer surface of the particles is contacted with the cationic polymer electrolyte to form cationic membrane shells, thereby obtaining cationic membrane shell-coated particles.

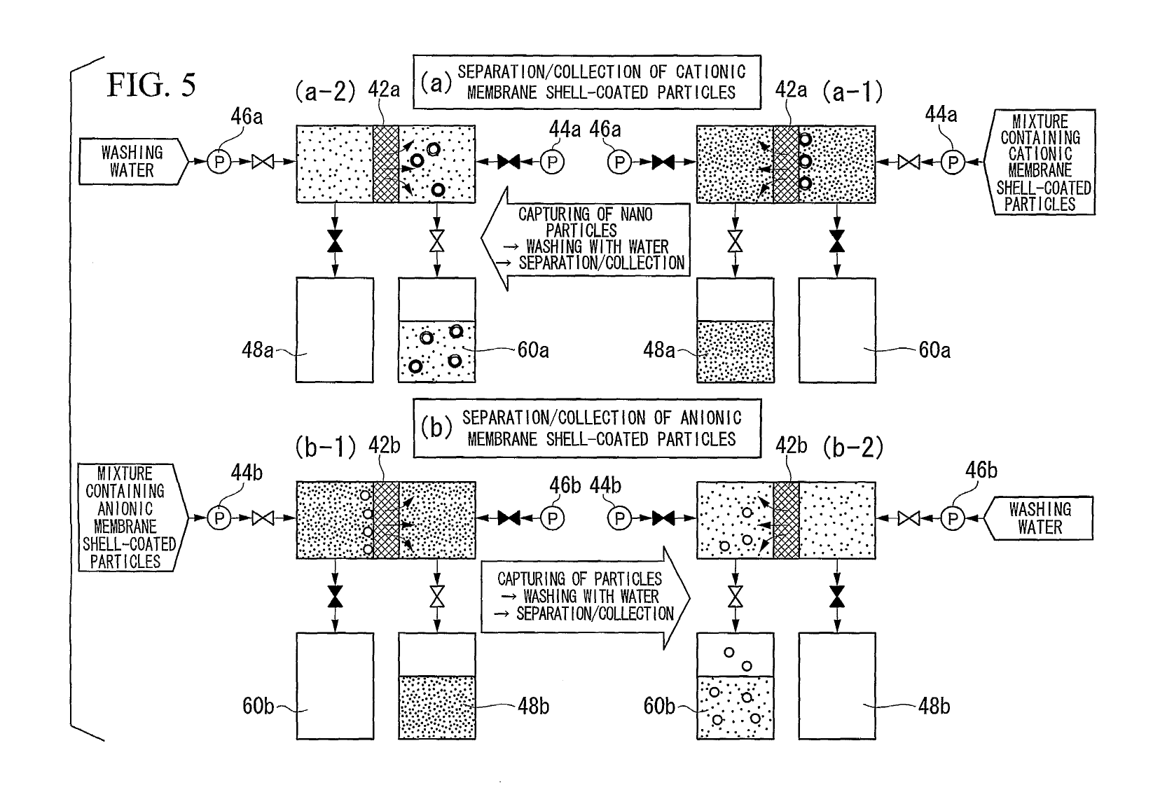

Thereafter, the cationic mixture of the particle suspension and the cationic polymer electrolyte solution is transferred to the separation/collection component 40a. The cationic mixture contains the cationic membrane shell-coated particles. The cationic membrane shell-coated particles are captured by the separation/collection component 40a, and separated and collected from the cationic mixture. The cationic membrane shell-coated particles which have been separated and collected are suspended in washing water to obtain a new particle suspension (suspension of cationic membrane shell-coated particles) which is collected in a collecting vessel 60a for suspension of cationic membrane shell-coated particles. With respect to a separation/collection component 40, a detailed explanation is given below with reference to FIGS. 5 to 9B.

Subsequently, using the pump 16, the suspension of cationic membrane shell-coated particles collected in the collecting vessel 60a is transferred to the microflow channel 32a for particle suspension within the anionic membrane shell-coating part 30. Likewise, using the pump 36, the anionic polymer electrolyte solution stored in the tank 34 for anionic polymer electrolyte membrane shell is transferred to the microflow channel 32b for anionic polymer electrolyte solution.

Then, the microflow channel for particle suspension 32a and the microflow channel 32b for anionic polymer electrolyte solution merge together to form a merged microflow channel 32c. In the merged microflow channel 32c, the suspension of the cationic membrane shell-coated particles and the anionic polymer electrolyte solution are mixed together, whereby the outer surface of the cationic membrane shell-coated particles is contacted with the anionic polymer electrolyte to form anionic membrane shells, thereby obtaining anionic membrane shell-coated particles.

Thereafter, the anionic mixture of the particle suspension and the anionic polymer electrolyte solution is transferred to the separation/collection component 40b. The anionic mixture contains the anionic membrane shell-coated particles. The anionic membrane shell-coated particles are captured by the separation/collection component 40b, and separated and collected from the anionic mixture. The anionic membrane shell-coated particles which have been separated and collected are suspended in washing water to obtain a new particle suspension (suspension of anionic membrane shell-coated particles) which is collected in a collecting vessel 60b for suspension of anionic membrane shell-coated particles.

As explained above, particles having two layers of polymer electrolyte membrane shells are obtained. When the particles having two layers of polymer electrolyte membrane shells are the final products, the suspension of anionic membrane shell-coated particles collected in the collecting vessel 60b is transferred to the collecting vessel 64 for multilayer membrane shell-coated particles using the pump 62, and the sequence of coating treatment is terminated.

When coating of three or more layers is to be formed, the pump 14b is used to transfer the suspension of anionic membrane shell-coated particles collected in the collecting vessel 60b to the microflow channel 22a for suspension particles within the cationic membrane shell-coating part 20, and coating treatment is performed in the same manner as described above, thereby obtaining particles having three layers of polymer electrolyte membrane shells. When the particles having three layers of polymer electrolyte membrane shells are the final products, the suspension of cationic membrane shell-coated particles collected in the collecting vessel 60a is transferred to the collecting vessel 64 for multilayer membrane shell-coated particles using the pump 62, and the sequence of coating treatment is terminated.

When coating of further layers is to be formed, the pump 16 is used to transfer the suspension of cationic membrane shell-coated particles collected in the collecting vessel 60a to the microflow channel 32a for suspension particles within the anionic membrane shell-coating part 30, and coating treatment is performed in the same manner as described above. By performing N times of the sequence of coating treatment as described above, particles having N layers of polymer electrolyte membrane shell can be obtained.

### (Explanation of Separation/Collection Component According to the Present Invention)

Next, the separation/collection component 40 for capturing cationic or anionic membrane shell-coated particles and separating and collecting the particles from a cationic or anionic mixture is described in detail, with reference to FIGS. 5 to 9B.

### <Explanation of Separation/Collection Component Using a Filter>

Firstly, one embodiment of a separation/collection component which separates and collects cationic or anionic particles using a filter is described below, with reference to FIG. 5. FIG. 5 shows the separation/collection process with a line diagram following the flow of the particle suspension and the polymer electrolyte solution, like in FIG. 4.

FIG. 5(a) shows the separation/collection component 40a for cationic membrane shell-coated particles, and FIG. 5(b) shows the separation/collection component 40b for anionic membrane shell-coated particles. The basic structures of the two separation/collection components are the same.

First, the separation/collection component 40a for cationic membrane shell-coated particles is described, with reference to FIG. 5(a).

The separation/collection component 40a for cationic membrane shell-coated particles is mainly composed of: a pump 44a for transferring a cationic mixture containing cationic membrane shell-coated particles to a nanoparticle filter 42a; the nanoparticle filter 42a for capturing cationic membrane shell-coated particles; a pump 46a for spraying washing water for back washing of the nanoparticle filter 42a; a collection vessel 48a for cationic mixture, where the remainder of the cationic mixture from which the cationic membrane shell-coated particles have been captured is collected; conduits for connecting each of the components; and valves for opening and closing conduits to thereby flow fluids to predetermined conduit routes. The cationic membrane shell-coated particles which have been separated and collected by the separation/collection component 40a are suspended in the washing water to obtain a new particle suspension containing the cationic membrane shell-coated particles, and the new particle suspension is transferred to and collected in the collecting vessel 60a for suspension of cationic membrane shell-coated particles.

An explanation is given following the flow of fluid containing cationic membrane shell-coated particles obtained in the cationic membrane shell-coating part 20. As shown in FIG. 5(a-1), a cationic mixture containing cationic membrane shell-coated particles is introduced into separation/collection component 40a, and is transferred to the nanoparticle filter 42a by the pump 44a provided within the separation/collection component 40a. A nanoparticle filter is a fine mesh filter capable of capturing particles having a particle diameter of nano size. In the present embodiment, the nanoparticle filter has a mesh size which t allows the cationic polymer electrolyte to pass through but not the cationic membrane shell-coated particles. By the nanoparticle filter 42a, cationic membrane shell-coated particles are captured, and the remainder of the cationic mixture is flowed to and collected in the collecting vessel 48a for cationic mixture.

Subsequently, as shown in FIG. 5(a-2), washing water is discharged to the nanoparticle filter 42a by the pump 46a on the side opposite to where the cationic membrane shell-coated particles are captured, thereby washing the nanoparticle filter 42a to remove the captured cationic membrane shell-coated particles from the nanoparticle filter 42a. Finally, the cationic particles suspended in the washing water as a new particle suspension are transferred to and collected in the collecting vessel 60a for cationic membrane shell-coated particles.

Next, the separation/collection component 40b for anionic membrane shell-coated particles is described, with reference to FIG. 5(b). The basic processes of the treatment are the same as in the separation/collection component 40a for cationic membrane shell-coated particles.

The separation/collection component 40b for anionic membrane shell-coated particles is mainly composed of: a pump 44b for transferring an anionic mixture containing anionic membrane shell-coated particles to a nanoparticle filter 42b; the nanoparticle filter 42b for capturing anionic membrane shell-coated particles; a pump 46b for spraying washing water for back washing of the nanoparticle filter 42b; a collection vessel 48b for anionic mixture, where the remainder of the anionic mixture from which the anionic membrane shell-coated particles have been captured is collected; conduits for connecting each of the components; and valves for opening and closing conduits to thereby flow fluids to predetermined conduit routes. The anionic membrane shell-coated particles which have been separated and collected by the separation/collection component 40b are suspended in the washing water to obtain a new particle suspension containing the anionic membrane shell-coated particles, and the new particle suspension is transferred to and collected in the collecting vessel 60b for suspension of anionic membrane shell-coated particles.

An explanation is given following the flow of fluid containing anionic membrane shell-coated particles obtained in the anionic membrane shell-coating part 30. As shown in FIG. 5(b-1), an anionic mixture containing anionic membrane shell-coated particles is introduced into the separation/collection component 40b, and is transferred to the nanoparticle filter 42b by the pump 44b provided within the separation/collection component 40b. In the present embodiment, the nanoparticle filter 42b has a mesh size which allows the anionic polymer electrolyte to pass through but not the anionic membrane shell-coated particles. By the nanoparticle filter 42b, anionic membrane shell-coated particles are captured, and the remainder of the anionic mixture is flowed to and collected in the collecting vessel 48b for anionic mixture.

Subsequently, as shown in FIG. 5(b-2), washing water is sprayed at the nanoparticle filter 42b by the pump 46b on the side opposite to where the anionic membrane shell-coated particles are captured, thereby washing the nanoparticle filter 42b to remove the captured anionic membrane shell-coated particles from the nanoparticle filter 42b. Finally, the anionic particles suspended in the washing water as a new particle suspension are transferred to and collected in the collecting vessel 60b for anionic membrane shell-coated particles.

As explained above, cationic (or anionic) membrane shell-coated particles can be reliably separated and collected from a cationic (or anionic) mixture by using a filter.

### <Explanation of Separation/Collection Component Using Rotary Roller>

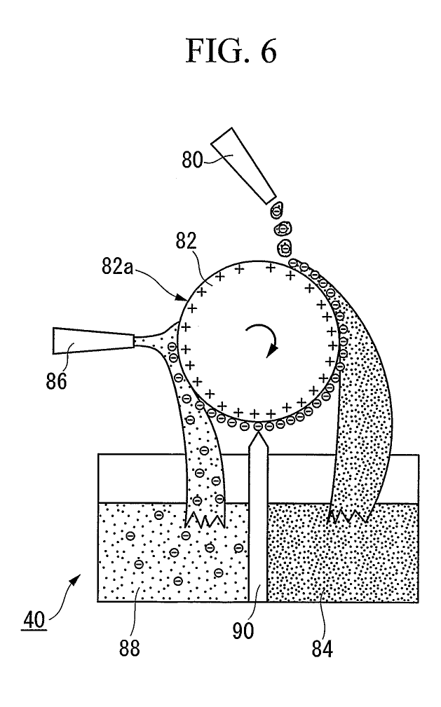

Next, one embodiment of a separation/collection component using a rotary roller is described, with reference to FIG. 6. FIG. 6 is a schematic diagram showing the side view of the separation/collection component 40 using a rotary roller. This separation/collection component 40 generally includes the separation/collection component 40a for cationic membrane shell-coated particles which is provided downstream of the cationic membrane shell coating part 20, and the separation/collection component 40b for anionic membrane shell-coated particles which is provided downstream of the anionic membrane shell coating part 30. Both components have the same structure. An explanation is given below, taking as an example separation and collection of anionic membrane shell-coated particles.

As shown in FIG. 6, the separation/collection component 40 using a rotary roller is mainly composed of: a rotary roller 82 provided with a cationic electrodeposited membrane shell on the roller surface 82a; a nozzle 80 for pouring an anionic mixture to the rotary roller 82 from the upper side thereof; a roller driving part (not shown) for rotating the rotary roller 82; a collecting vessel 84 for anionic mixture, where the anionic mixture is collected; a spraying nozzle 86 for spraying washing water on the roller surface 82a; a collecting vessel 88 for suspension of anionic membrane shell-coated particles, where anionic membrane shell-coated particles suspended in washing water are collected as a new particle suspension; and a separator 90. In the present embodiment, the suspension of anionic membrane shell-coated particles collected in the collecting vessel 88 is transferred to the above-mentioned collecting vessel 60b. However, the collecting vessel 60b can be directly used instead of the collecting vessel 88. Further, the spraying nozzle 86 is equipped with a pump (not shown) for spraying washing water. In the present embodiment, the roller driving part rotates the rotary roller 82 at a predetermined revolution rate by the driving force of an electric motor. However, any other driving sources may be used.

An explanation is given following the flow of fluids containing anionic membrane shell-coated particles. First, using the nozzle 80, an anionic mixture containing anionic membrane shell-coated particles obtained in the anionic membrane shell-coating part 30 is poured from the upper side of the rotary roller 82 to the roller surface 82a. The roller surface 82a is provided with a cationic electrodeposited membrane shell having a charge opposite to that of the outermost layer of the anionic membrane shell-coated particles contained in the anionic mixture, and the anionic membrane shell-coated particles are attracted and captured on the roller surface 82a by electrostatic force.

On the other hand, the remainder of the anionic mixture from which the anionic membrane shell-coated particles have been captured is allowed to fall and is collected in the collecting vessel 84 for anionic mixture, which is provided at a lower side of the rotary roller 82. For enhancing the collection efficiency of the anionic membrane shell-coated particles, the anionic mixture collected in the collecting vessel 84 may be pumped up, and the process of pouring from the nozzle 80 to the roller surface 82a of the rotary roller 82 may be repeatedly performed.

The anionic membrane shell-coated particles captured on the roller surface 82a of the rotary roller 82 are moved to the upper side of the collecting vessel 88 for suspension of anionic membrane shell-coated particles by the rotation of the rotary roller 82. Then, washing water is sprayed at the roller surface 82a of the rotary roller 82 from the spraying nozzle 86 to wash the roller surface 82a, thereby removing the anionic membrane shell-coated particles captured on the roller surface 82a.

Thereafter, a new particle suspension containing the removed anionic membrane shell-coated particles and washing water is allowed to fall and is collected in the collecting vessel 88 for suspension of anionic membrane shell-coated particles, which is provided at the lower side of the rotary roller 82. The separator 90 prevents the suspension of anionic membrane shell-coated particles from falling into the collecting vessel 84 for anionic mixture.

The separation/collection of cationic membrane shell-coated particles is basically the same, and hence, explanation is omitted.

### <Explanation of Other Embodiments of Separation/Collection Component Using a Rotary Roller>

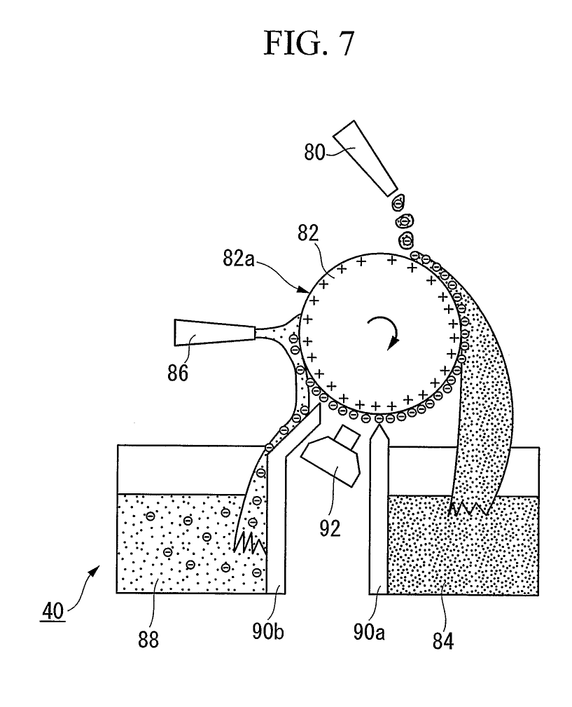

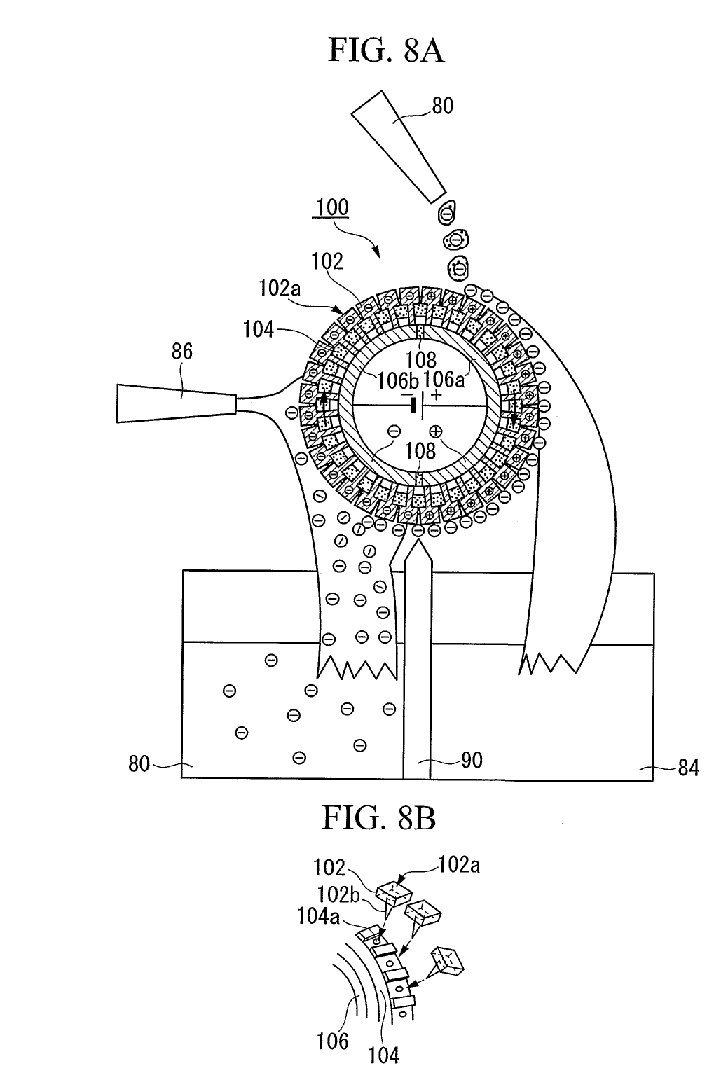

Next, other embodiments of the separation/collection component 40 using a rotary roller are described, with reference to FIGS. 7, 8A and 8B.

### Other Embodiment 1

The other embodiment 1 shown in FIG. 7 is the separation/collection component using a rotary roller 40 as shown in FIG. 6, which is further provided with a microelectrostatic elimination device 92. A microelectrostatic elimination device is a device for removing static electricity by, for example, applying voltage, using a corona discharge, or using photoionization.

In the present embodiment, the roller surface 82a provided with a cationic electrodeposited membrane shell having a charge opposite to that of the outermost layer of the anionic membrane shell-coated particles captures anionic membrane shell-coated particles, and the rotary roller 82 rotates so that the captured anionic membrane shell-coated particles move to a position on the upper side of the collecting vessel 88 for suspension of anionic membrane shell-coated particles. Then, at this position, the positive charge of the roller surface 82a is neutralized by the microelectrostatic elimination device 92 to eliminate the static electricity. In this manner, the electrostatic force which was attracting the anionic membrane shell-coated particles is weakened, so that the anionic membrane shell coated particles can be reliably removed from the roller surface 82a by spraying of washing water from the spraying nozzle 86. Finally, a particle suspension containing the anionic membrane shell-coated particles removed is reliably allowed to fall and is collected in the collecting vessel 88 for suspension of anionic membrane shell-coated particles by the separator 90b.

### Other Embodiment 2

Next, the other embodiment 2 of the separation/collection component 40 using a rotary roller is described, with reference to FIGS. 8A and 8B. Also in the present embodiment, an explanation is given, taking as an example separation and collection of anionic membrane shell-coated particles. FIG. 8A is a schematic diagram showing the side view of a separation/collection component 40, and FIG. 8B is a partial perspective view. In the present embodiment, voltage is applied to impart an electric charge to a roller surface 102a of the rotary roller 100. The pole of the electric charge of a roller surface 102a is switchable depending on the rotating position of the rotary roller 100.

In the present embodiment, the rotary roller 100 is composed of a support ring 104 and a plurality of capturing pieces 102. As shown in FIG. 8B, capturing pieces 102 made of a conductive material such as copper are secured to the entire periphery of the support ring 104 made of an insulative material. The side surface of the outside diameter of the capturing pieces 102 secured to the support ring 104 constitutes the roller surface 102a. The support ring 104 is provided with through-holes 104a with a number corresponding to the number of capturing pieces 102. Protruding portions 102b of the capturing pieces 102 are respectively inserted in the through-holes 104, so as to secure the capturing pieces 102 to the support ring 104 on the outer periphery thereof. The support ring 104 has bumps between adjacent capturing pieces 102, so that the capturing pieces 102 are electrically insulated from each other.

Further, as shown in FIG. 8A, the rotary roller 100 has in the inner portion thereof an electrode ring 106, which is divided into a positive-side ring 106a and a negative-side ring 106b. Between the two electrode rings, insulation pieces 108 made of an insulative material are inserted to electrically insulate the two rings from each other. A positive charge is imparted to the positive-side ring 106a, and a negative charge is imparted to the negative-side ring 106b.

In the rotary roller 100, the protruding portions 102b protruding towards the inner portion of the rotary roller 100 (inner portion of the support ring 104) are configured so as to be contacted with the electrode ring 106. Thus, the roller surface 102a (capturing pieces 102) exhibits a charge which is the same as the electrode ring 106a or 106b to which the roller surface 102a is contacted through protruding portions 102b.

The rotary roller 100 rotates by a roller driving part (not shown), but the electrode ring 106 is stationary. When the rotary roller 100 is rotated in this state, the tips of the protruding portions slide over the electrode ring 106. The roller surface 102a (capturing pieces 102) exhibits a positive charge at a position on the right-hand side of the figure, namely, at a position on the upper side of the collecting vessel 84 for anionic mixture. On the other hand, when the rotary roller 100 rotates from a position on the right-hand side of the figure (a position on the upper side of the collecting vessel 84 for anionic mixture) to a position on the left-hand side of the figure, namely, a position on the upper side of the collecting vessel 88 for suspension of anionic membrane shell-coated particles, the roller surface 102a (capturing pieces 102) exhibits a negative charge.

Thus, when an anionic mixture containing anionic membrane shell-coated particles is poured from the upper side of the rotary roller 100 to the roller surface 102a using the nozzle 80, the anionic membrane shell-coated particles are attracted to and captured on the roller surface 102 by electrostatic force.

On the other hand, when the rotary roller 100 rotates so that the roller surface 102a having captured the anionic membrane shell-coated particles moves to a position on the upper side of the collecting vessel 88 for suspension of anionic membrane shell-coated particles, the charge of the roller surface 102a switches from a positive charge to a negative charge, whereby the electrostatic force attracting the anionic membrane shell-coated particles is changed to a repulsive force to remove the anionic membrane shell-coated particles from the roller surface 102a.

Further, the anionic membrane shell-coated particles can be removed from the roller surface 102a more reliably by spraying of washing water from spraying nozzle 86. The suspension of anionic membrane shell-coated particles removed from the roller surface 102a is prevented from falling into the collecting vessel 84 for anionic mixture by the separator 90.

In the present embodiment described above, for further ensuring the electric connection between the tips of the protruding portions 102b and the electrode ring 106, springs or the like can be used for urging the protruding portions 102b or the electrode ring 106, or the tips of the protruding parts 102b may be imparted a brush shape or provided with a roller. Alternatively, a crawler may be used instead of a rotary roller.

### <Explanation of Separation/Collection Component Using a Flow Channel Having an Electric Charge>

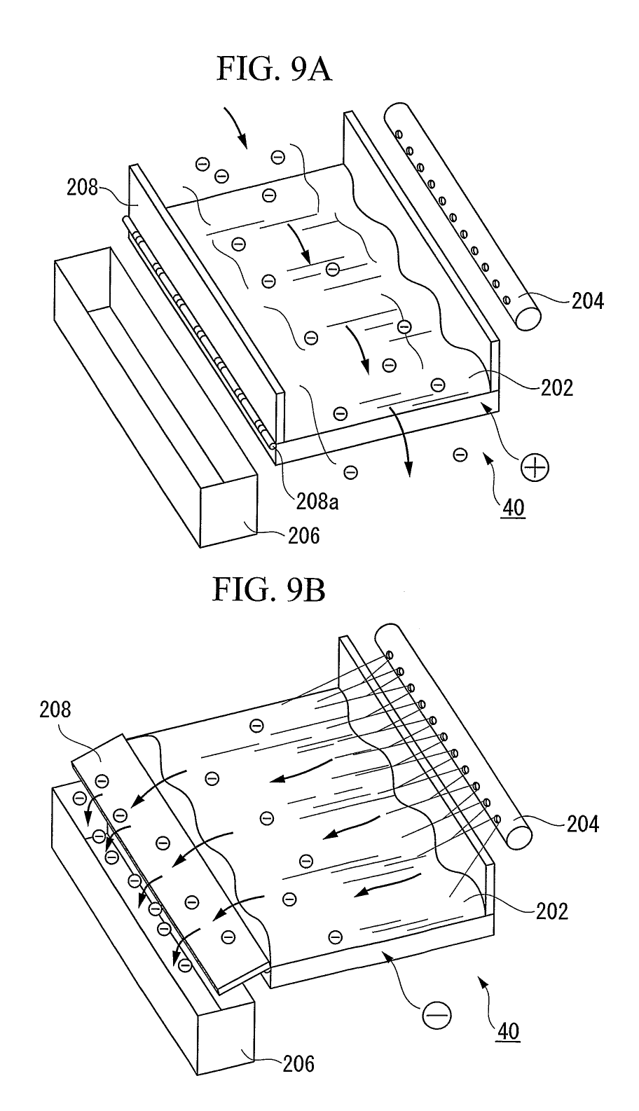

Next, one embodiment of a separation/collection component using a flow channel having an electric charge is described, with reference to FIGS. 9A and 9B. FIGS. 9A and 9B are perspective views showing a separation/collection component using a flow channel having an electric charge, and a separation/collection process. An explanation is given below, taking as an example separation and collection of anionic membrane shell-coated particles.

FIG. 9A shows a step of capturing anionic membrane shell-coated particles within an anionic mixture on the surface of a flow channel 202 by electrostatic force. Further, FIG. 9B shows a step of washing off the captured anionic membrane shell-coated particles from the flow channel 202 by spraying washing water, and collecting the anionic membrane shell-coated particles together with the washing water in a collecting vessel 206 for suspension of anionic membrane shell-coated particles.

In the present embodiment, the separation/collection component 40 is mainly composed of: a flow channel 202 in which the pole of the electric charge on the surface thereof is switchable; a nozzle 204 for spraying washing water from a direction perpendicular to the flow of the anionic mixture; a collecting vessel 206 for a new particle suspension containing the anionic membrane shell-coated particles and washing water; and a rotary plate 208 which is rotatable around the center of rotation 208a, and which functions as a side wall of the flow channel 202 for anionic mixture (see FIG. 9A) or a flow channel for the new particle suspension containing the anionic membrane shell-coated particles and washing water.

First, as shown in FIG. 9A, an anionic mixture is passed through the flow channel 202 in the direction of the arrows. At this time, by rendering the charge of the surface of the flow channel 202 positive, the anionic membrane shell-coated particles contained in the anionic mixture are captured on the surface of the flow channel 202 by electrostatic force.

After passing a predetermined amount of the anionic mixture, the rotary plate 208 which is facing a direction perpendicular to the flow of the anionic mixture in FIG. 9A is rotated around the center of rotation 208a by an actuator (not shown), to a state as shown in FIG. 9B.

Then, as shown in FIG. 9B, the charge of the surface of the flow channel 202 is switched from a positive charge to a negative charge, and washing water is sprayed from the washing nozzle 204 in the direction as indicated with the arrows to the surface of the flow channel 202.

In this case, when the charge of the surface of the flow channel 202 is switched from a positive charge to a negative charge, a repulsive force is generated between the flow channel 202 and the anionic membrane shell-coated particles attracted to the surface of the flow channel 202 by electrostatic force, so that the anionic membrane shell-coated particles can be easily washed off from the flow channel 202 with washing water. Then, a new particle solution containing the washing water and the anionic membrane shell-coated particles flows over the rotary plate 208 and is collected in the collecting vessel 206 for suspension of anionic membrane shell-coated particles.

By providing two separation/collection components 40 using a flow channel having an electric charge and using them alternately, separation and collection of electrolyte membrane shell-coated particles from a particle suspension can be continuously performed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention.

1. An apparatus for coating particles with a polymer electrolyte, which comprises at least one polymer membrane shell-coating part,
said particles being coated with a membrane shell in said at least one polymer membrane shell-coating part by performing a step comprising contacting said particles having a predetermined charge with said polymer electrolyte having a charge opposite to that of the outer surface of said particles, thereby forming a membrane shell on the surface of the outermost layer of said particles.

2. The apparatus according to claim 1, wherein said particles and said polymer electrolyte are contained in a particle suspension and a polymer electrolyte solution, respectively, and
wherein said particle suspension and said polymer electrolyte solution are mixed together in said at least one polymer membrane shell-coating part to thereby contact the surface of the outermost layer of said particles with said polymer electrolyte.

3. The apparatus according to claim 2, wherein said particle suspension and said polymer electrolyte solution are mixed together by merging the flow of said particle suspension with the flow of said polymer electrolyte solution.

4. The apparatus according to claim 3, wherein said at least one polymer membrane shell-coating part has at least one microflow channel,
wherein said particle suspension and said polymer electrolyte solution are passed through said at least one microflow channel.

5. The apparatus according to any one of claims 2 to 4, which further comprises a collection/separation component,
wherein said particle suspension and said polymer electrolyte solution are mixed together in said at least one polymer membrane shell-coating part, followed by separating and collected said particles from the resulting mixture of said particle suspension and said polymer electrolyte solution by said collection/separation component.

6. The apparatus according to claim 5, wherein said separation/collection component is provided with a filter, and
wherein said particles are separated and collected from the resulting mixture of said particle suspension and said polymer electrolyte solution by using said filter.

7. The apparatus according to claim 5, wherein said collection/separation component is provided with a rotary roller having a charge on the surface thereof which is opposite to the charge on the surface of the outermost layer of said membrane shell-coated particles,
wherein said particles in the resulting mixture of said particle suspension and said polymer electrolyte solution are separated therefrom by capturing said particles on the surface of said rotary roller at a position where the surface of said rotary roller contacts with the resulting mixture of said particle suspension and said polymer electrolyte solution, and
wherein said captured particles are removed and collected from the surface of said rotary roller at a position remote from the resulting mixture of said particle suspension and said polymer electrolyte solution.

8. The apparatus according to claim 7, wherein said particles are removed from the surface of said rotary roller by spraying the surface of said rotary roller with a liquid.

9. The apparatus according to claim 7 or 8, wherein said separation/collection component is provided with a microelectrostatic elimination device for canceling the charge on the surface of said rotary roller.

10. The apparatus according to claim 7 or 8, wherein the pole of the charge on the surface of said rotary roller is switchable depending on the rotating position,
wherein said particles in the resulting mixture of said particle suspension and said polymer electrolyte solution are separated therefrom by switching the charge on the surface of said rotary roller to the pole opposite to that of the charge on the surface of the outermost layer of said particles and capturing said particles on a surface of said rotary roller at a position where the surface of said rotary roller contacts with the resulting mixture of said particle suspension and said polymer electrolyte solution, and
wherein said particles are removed and collected from the surface of said rotary roller at a position remote from the resulting mixture of said particle suspension and said polymer electrolyte solution by switching the charge on the surface of said rotary roller to the same pole as that of the charge on the surface of the outermost layer of said particles.

11. The apparatus according to any one of claims 1 to 10, which is connected to an apparatus for producing particles,
wherein a step for producing said particles is performed, followed by the coating of said particles with said polymer electrolyte.

12. A method for coating particles with a polymer electrolyte, comprising:
providing particles having a predetermined charge on an outer surface thereof and a polymer electrolyte having a charge opposite to that of the outer surface of said particles; and
coating said particles with said polymer electrolyte by performing a step comprising contacting said particles with said polymer electrolyte, thereby forming a membrane shell on the surface of the outermost layer of said particles.

13. The method according to claim 12, wherein said particles and said polymer electrolyte are contained in a particle suspension and a polymer electrolyte solution, respectively, and
wherein said particle suspension and said polymer electrolyte solution are mixed together to thereby contact the surface of the outermost layer of said particles with said polymer electrolyte.

14. The method according to claim 13, wherein said particle suspension and said polymer electrolyte solution are mixed together by merging the flow of said particle suspension with the flow of said polymer electrolyte solution.
